(19) United States
(12) Patent Application Publication
(10) Pub. No.: US 2026/0274100 A1
(43) Pub. Date: Sep. 17, 2026

(54) ELECTRIC RAIL VEHICLE CHARGING APPARATUS

(71) Applicant: First Greater Western Limited, Swindon (GB)

(72) Inventors: Stuart Charles Bower, Rugby, Warwickshire (GB); Ian Campbell-Kelly, Stone, Staffordshire (GB); Julian Guy Fletcher, Leamington Spa, Warwickshire (GB); David Thomas Horton, Lower Tysoe, Warwickshire (GB); Peter Mason, Stone, Staffordshire (GB)

(21) Appl. No.: 18/878,018

(22) PCT Filed: Jun. 15, 2023
(86) PCT No.: PCT/GB2023/051573

§ 371 Date: Dec. 21, 2024

(30) Foreign Application Priority Data
Jun. 22, 2022 (GB) 2209176.3
Jul. 1, 2022 (GB) 2209686.1
Aug. 30, 2022 (GB) 2212545.4
Nov. 10, 2022 (GB) 2216810.8

(51) Int. Cl. B60L 53/35; B60L 5/08; B60L 53/30; B60M 7/00

(52) U.S. Cl. CPC B60L 53/35; B60L 5/08; B60L 53/32; B60M 7/003; B60L 2200/26

(57) ABSTRACT

A charging apparatus for installation on an electric rail vehicle having a battery, the charging apparatus comprising a controller and a charging shoe electrically connectable to a battery. The charging shoe is configured to be movable between a retracted position and a deployed position, and is electrically connectable to a trackside charging contact when in the deployed position. The controller is configured to detect a position of the electric rail vehicle relative to the trackside charging contact, and cause the charging shoe to: move from the retracted position to the deployed position prior to the charging shoe being positioned over the charging contact, and/or while the battery electric rail vehicle is in motion, thereby sliding the charging shoe along at least a first portion of the trackside charging contact, and/or move from the deployed position to the retracted position subsequent to the electric rail vehicle starting to move away from the trackside charging contact, thereby sliding the charging shoe along at least a second portion of the trackside charging contact.

### FIELD OF INVENTION

The present invention relates to systems and methods for charging electric vehicles, and in particular battery electric rail vehicles.

### BACKGROUND

Ongoing electrification of rail vehicles is a key part of de-carbonising the rail transport sector. However, many electric rail vehicles require a permanent connection to a high voltage power supply infrastructure, for example catenary or electrified “third rails”. Such infrastructure is highly expensive, and its installation is not possible in all locations.

One known solution is to provide battery-powered rail vehicles. Such vehicles do not require additional infrastructure along the whole length of a route. Instead, on-board batteries are charged at predetermined locations along the route to ensure that the vehicle has sufficient stored energy to traverse the route.

Patent application publication WO 2019229479 A1 describes a charging system for a battery electric rail vehicle including a charging rail dimensioned to be fully coverable by a train carriage; a power supply for charging an electric train battery, the power supply being configured to selectively supply a charging current to the charging rail; and, a sensor apparatus configured to detect the position and/or movement of a train carriage over the charging rail; in which the sensor is connected to the power supply such that the charging current is only supplied to the charging rail when the train carriage at least partially covers the charging rail.

Patent publication US 2018/141452 A1 describes a charging arrangement for a battery-electric tram, in which a deployable contact is lowered from the tram to connect with a power supply contact in the ground. The contact is only lowered when the tram is stationary.

It is desired to further improve the effectiveness and speed with which battery-electric rail vehicles can be charged at a charging location.

### SUMMARY OF INVENTION

In a first aspect of the present invention, there is provided a charging apparatus for installation on an electric rail vehicle having a battery, the charging apparatus comprising a controller and a charging shoe (for example an electrically conductive element of a shoegear, preferably fabricated from a carbon ceramic material) electrically connectable to a battery. The charging shoe is preferably positioned beneath the electric rail vehicle, and is configured to be movable between a retracted position and a deployed position, and is electrically connectable to a trackside charging contact (for example a stationary contact such as a charging rail positioned between running rails) when in the deployed position. The controller is configured to detect a position of the electric rail vehicle relative to the trackside charging contact, and cause the charging shoe to: move from the retracted position to the deployed position prior to the charging shoe being positioned over the charging contact, and/or while the battery electric rail vehicle is in motion, thereby sliding/wiping/brushing the charging shoe along at least a first portion of the trackside charging contact, and/or move from the deployed position to the retracted position subsequent to the electric rail vehicle starting to move away from the trackside charging contact, thereby sliding/wiping/brushing the charging shoe along at least a second portion of the trackside charging contact.

Advantageously, sliding the charging shoe over the charging contact in this manner helps to remove debris and corrosion from the trackside charging contact, and further can deposit electrically conductive, corrosion resistant material on the trackside charging contact. Accordingly, this arrangement results in improved electrical contact between the charging shoe and trackside charging contact, leading to more efficient and faster charging of the battery.

In a preferred embodiment, the charging apparatus further comprises a receiver (preferably an RF transceiver/interrogator) configured to receive a first signal from a first trackside transmitter (preferably an RFID tag/beacon), wherein the controller is configured to cause the charging shoe to move from the retracted position to the deployed position (for example by providing instructions/a control signal to an actuator connected to the charging shoe) in response to the receiving the signal. This provides an effective means for automating initiation of shoe deployment. Optionally the receiver is configured to receive a second signal from a second trackside transmitter (again, preferably an RFID tag/beacon), and wherein the controller is configured to determine that the electric rail vehicle is positioned such that the charging shoe in the deployed position is in contact with the trackside charging contact based at least in part on the receipt of the second signal. This provides a convenient means for determining that the electric rail vehicle is correctly positioned for charging to commence.

Preferably the charging apparatus comprises an actuator (for example a pneumatic actuator) configured to move the charging shoe from the retracted position to the deployed position, wherein: when the charging shoe is in the deployed position and in contact with the stationary charging rail, and the battery electric rail vehicle is stationary, the controller is configured to cause the actuator to maintain a force between the charging shoe and the stationary charging rail above a threshold force (for example by ensuring an air pressure supplied to the actuator remains above a predetermined threshold/within a predefined range). Advantageously this ensures good electrical contact between the charging shoe and the trackside charging rail even in the event that the electric rail vehicle rises on its suspension as passengers disembark at a platform.

Optionally the charging apparatus further comprises a marker detectable by a trackside proximity sensor, where in the controller is configured to determine that the electric rail vehicle is positioned such that the charging shoe in the deployed position is in contact with the trackside charging contact based at least in part on receiving an indication that the marker has been detected by a trackside proximity sensor. Beneficially, this provides a further confirmation that the electric rail vehicle is positioned correctly for charging to commence/continue.

In a second aspect of the present invention there is provided a rail vehicle comprising the charging apparatus above.

In a third aspect of the present invention, there is provided a method of charging a battery electric rail vehicle having a charging shoe, wherein the charging shoe is configured to move between a retracted position to a deployed position and wherein the charging shoe is electrically connectable to a trackside charging contact when in the deployed position. The method comprises: detecting that the battery electric rail vehicle is approaching the trackside charging contact; causing the charging shoe to move from the retracted position to the deployed position prior to the charging shoe being positioned over the charging contact, and/or while the battery electric rail vehicle is in motion; contacting the trackside charging contact with the charging shoe in the deployed position as the battery electric rail vehicle continues to move, such that the charging shoe slides along at least a first portion of the trackside charging contact.

Optionally, detecting that the battery electric rail vehicle is approaching a trackside charging contact comprises receiving, at a receiver at the rail vehicle, a first signal from a first trackside transmitter.

In the preferred embodiment, the charging shoe is caused to move from the retracted position to the deployed position responsive to receiving, at a receiver, a second signal from a second trackside transmitter.

Optionally the method further comprises detecting that the battery electric rail vehicle is positioned such that the charging shoe is in contact with the trackside charging contact by one or more of: receiving, at a receiver, a third signal from a third trackside transmitter; that a trackside marker has been detected by an on-board proximity sensor; and determining that an on-board marker has been detected by a trackside proximity sensor.

In the preferred embodiment, the method further comprises maintaining contact between the charging shoe in the deployed position as the battery electric rail vehicle starts to move, such that the charging shoe slides along at least a second portion of the trackside charging contact; subsequently causing the charging shoe to move from the deployed position to the retracted position.

A fourth aspect of the present invention provides a battery electric rail vehicle charging system comprising a battery electric rail vehicle and a trackside charging infrastructure. The battery electric rail vehicle comprises: first wheels configured to run on a first running rail and second wheels configured to run on a second running rail, a battery, a first charging shoe, and a second charging shoe. The trackside charging infrastructure comprises: a trackside charging contact configured to be connected to a first electrical potential during charging of the battery; a first further trackside charging contact and a second further trackside charging contact, configured such that either the first further trackside charging contact or the second further trackside charging contact is connected to a second electrical potential during charging of the battery. The trackside charging contact is positioned substantially equidistant between a first running rail and a second running rail. The first further trackside charging contact is positioned between the trackside charging contact and the first running rail. The second further trackside charging contact is positioned between the trackside charging contact and the second running rail. The first charging shoe is positioned so as to be contactable to the trackside charging contact, and wherein the second charging shoe is positioned so as to be contactable with either the first further trackside charging contact or the second further trackside charging contact.

Advantageously, a battery electric rail vehicle using this system can charge its battery at the trackside charging infrastructure regardless as to the orientation and direction of travel of the vehicle. Further, complex polarity switching mechanisms are not required at either the trackside charging infrastructure or the on-board charging apparatus in order to achieve this. Thus, the system provides an effective a direction-agnostic charging arrangement without the need for complex high current switching circuitry.

Preferably the battery electric vehicle further comprises an on-board controller, and the first charging shoe is movable between a retracted position and a deployed position; and the on-board controller is configured to control the first contact shoe to: move from the retracted position to the deployed position prior to the charging shoe being positioned over the charging contact, and/or while the battery electric rail vehicle is in motion, thereby sliding the charging shoe along at least a first portion of the trackside charging contact, and/or move from the deployed position to the retracted position subsequent to the electric rail vehicle starting to move away from the trackside charging contact, thereby sliding the charging shoe along at least a second portion of the trackside charging contact.

### BRIEF DESCRIPTION OF THE DRAWINGS

Embodiments of the present invention will now be described, by way of example only, with reference to the following figures. Like reference numerals refer to like elements throughout.

FIG. 1A shows a schematic side view of a portion of a battery electric rail vehicle.

FIG. 1B shows a schematic top view of a portion of the battery electric rail vehicle of FIG. 1A.

FIG. 2A shows a schematic top view of trackside charging infrastructure.

FIG. 2B shows a schematic side view of the trackside charging contact of the trackside charging infrastructure of FIG. 2A.

FIG. 2C shows a schematic top view of an alternative trackside charging infrastructure.

FIG. 2D shows a schematic side view of the trackside charging contact of the trackside charging infrastructure of FIG. 2C.

FIG. 2E shows a schematic top view of further alternative trackside charging infrastructure.

FIG. 2F shows a schematic top view of an arrangement including the trackside charging infrastructure of FIG. 2E and the trackside charging infrastructure of FIG. 2A.

FIGS. 3A to 3C show schematic side views of the battery electric rail vehicle of FIGS. 1A and 1B and the trackside charging contact of FIGS. 2A and 2B at respective stages of a shoegear operation procedure.

FIG. 4 shows a schematic partial top view of a section of track.

FIG. 5 shows a flow diagram illustrating a method for operating the charging shoe.

### DETAILED DESCRIPTION

Embodiments of the invention are described below in the context of battery electric multiple units. However, it will be readily appreciated that the invention is equally applicable to battery electric locomotives and other battery powered electric rail vehicles, including trams and light rail vehicles.

### Charging Apparatus and Trackside Charging Infrastructure

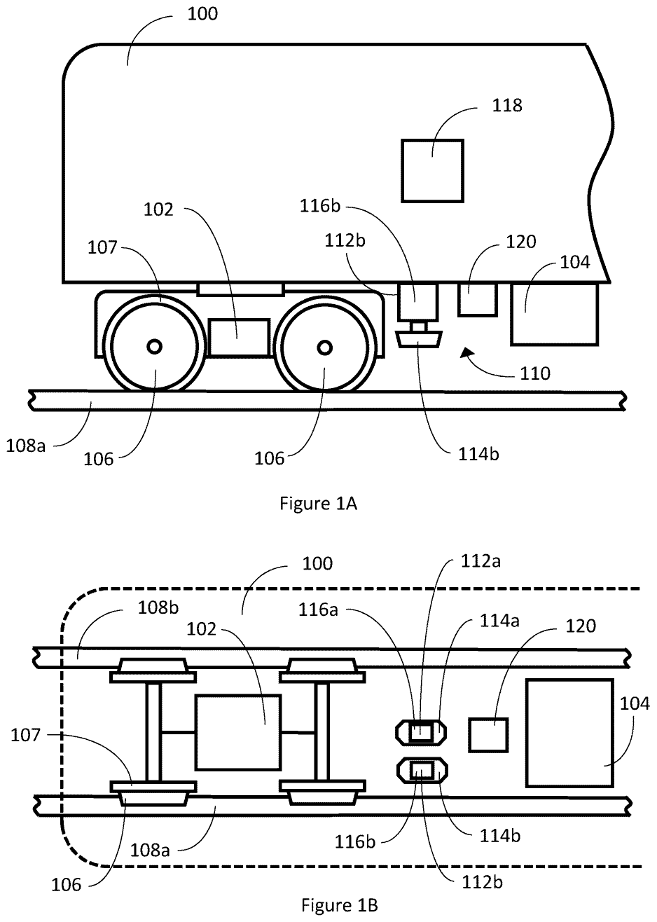

FIG. 1A shows a schematic side view of a portion of a battery electric rail vehicle 100. As shown, the battery electric rail vehicle 100 is a driving motor car in a battery electric multiple unit (BEMU), though it will be appreciated that the below applies equally to other types of battery electric rail vehicle. FIG. 1B shows a schematic top view of a portion of the same battery electric vehicle 100. In use, an electric motor 102 is configured to draw power from an on-board battery 104 and drive a plurality of driving wheels 106. The driving wheels 106 each have a flange 107 and run along first and second running rails 108a, 108b in the conventional manner.

The vehicle 100 also includes on-board (that is, vehicle-side) charging apparatus 110. The on-board charging apparatus 110 comprises at least one, and preferably at least two shoegear 112a, 112b positioned beneath the body of the driving motor car 100. Each shoegear 112a, 112b comprises a charging shoe 114a, 114b mounted to a respective actuator 116a, 116b. In the preferred embodiment, the charging shoes 114a, 114b are formed from a carbon-copper composite material, with a metallised carbon contact material, as is known in the art for use in conventional “third rail” electric rail vehicles (for example a carbon ceramic material with embedded copper threads such as MY258P grade Morganite® produced by Morgan Advanced Materials). We note that such materials are particularly advantageous over more traditional cast iron shoes used for some third rail electric vehicles in the present context materials such as cast-iron risk being welded to the charging rail due to the high currents involved during charging and the fact the vehicle is stationary during charging in the present invention. In one example, the charging shoes 114a, 114b are rated to carry currents up to 1000A at 850V. Preferably the actuators 116a, 116b are pneumatic actuators, although hydraulic or electromechanical actuators can alternatively be used. The use of pneumatic actuators is particular beneficial, in that it allows for flexibility in ride height due to wheel wear or vehicle load (which might change while charging is in progress) while maintaining a constant force on the charging shoe 114a, 114b. Pneumatic actuators allow for rapid deployment of the charging shoe 114a, 114b. As a further advantage, pneumatic actuators can also make use of pre-existing compressed air supplies on the electric rail vehicle 100.

It will be appreciated that multiple charging apparatuses 110 may be provided. Preferably, driving motor car 100 is part of a train consist, for example part of a multiple unit comprising a second driving motor unit (not shown) and optionally one or more non-driving carriages (not shown) between the driving motor car 100 and the second driving motor car. In such cases, one or more further charging apparatuses 110 can be provided on the second driving motor car and/or non-driving carriages. Alternatively or in addition, driving motor car 100 may be provided with two or more charging apparatuses 110.

A controller 118 is also provided to control actuation of the actuators 116a, 116b. Each actuator 116a, 116b, under control of the controller 118, is configured to move its associated charging shoe 114a, 114b between different positions, as explained in greater detail below. While the present embodiment as illustrated in FIGS. 1A and 1B employs a different actuator 116a, 116b for each charging shoe 114a, 114b, in alternative embodiments a single actuator may be used to simultaneously change the position of all of the charging shoes 114a, 114b provided in the on-board charging apparatus 110. In some examples, the controller 118 is or includes a traction control unit.

Preferably, the charging apparatus also includes a receiver 120 configured to receive wireless communication signals, for example a transceiver for interrogating RFID beacons.

The shoegear 112a, 112b can be positioned at various points on the underside of the driving motor car 100. A preferred position is proximate to, but forward of a trailing bogie of the driving motor car 100—this position helps ensure that the trackside charging contacts (discussed below) are fully covered by the driving motor car 100 itself during charging. In any case the shoegear 112a, 112b is preferably positioned such that, during charging, the trackside charging contacts are fully covered by one or more vehicles making up the train rake, either alone or in combination. For example, the trackside charging contacts may be entirely covered by the driving motor car 100 alone, or may be partially covered by the driving motor car 100 and partially covered by the next vehicle in the train coupled to the driving motor car (such that the trackside charging contacts are completely covered by the train rake).

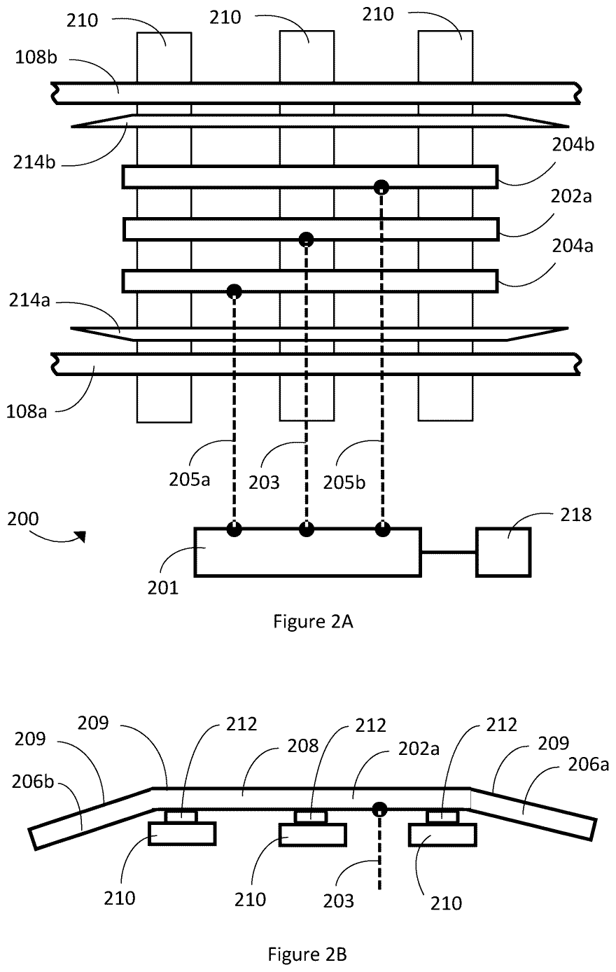

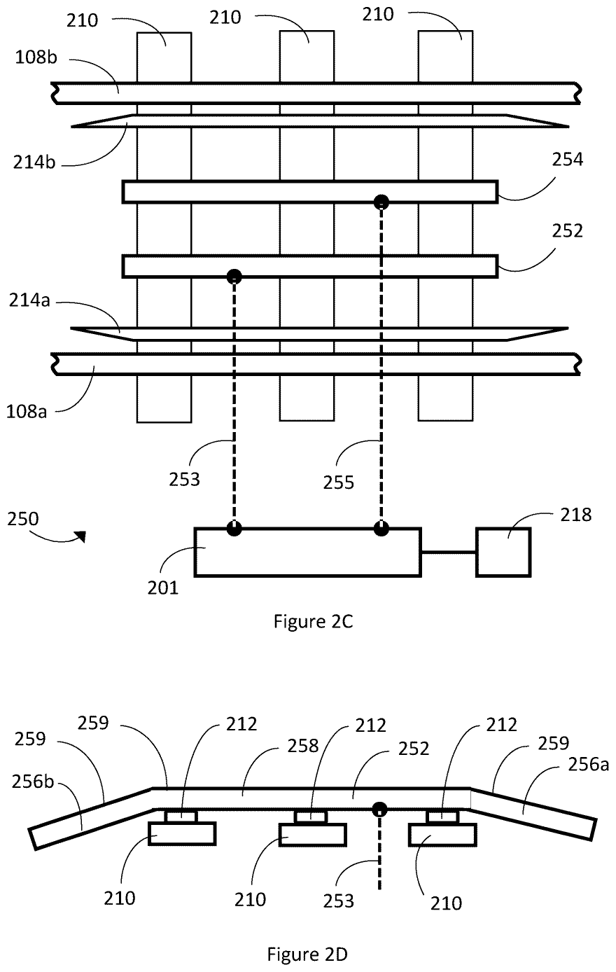

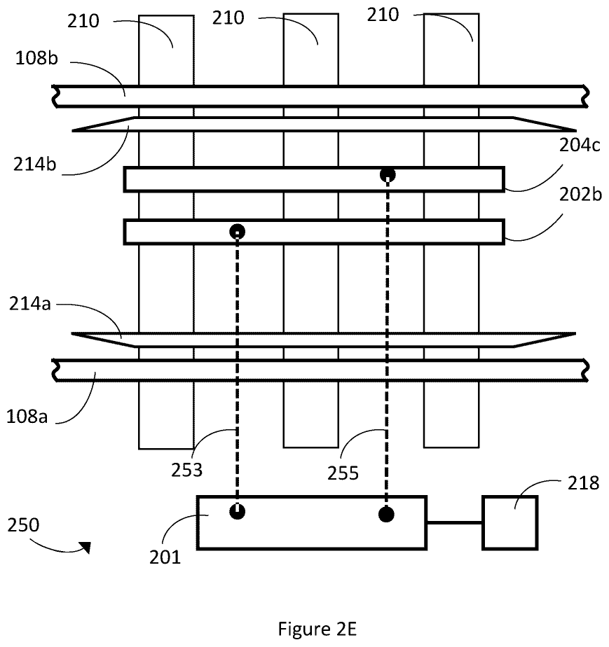

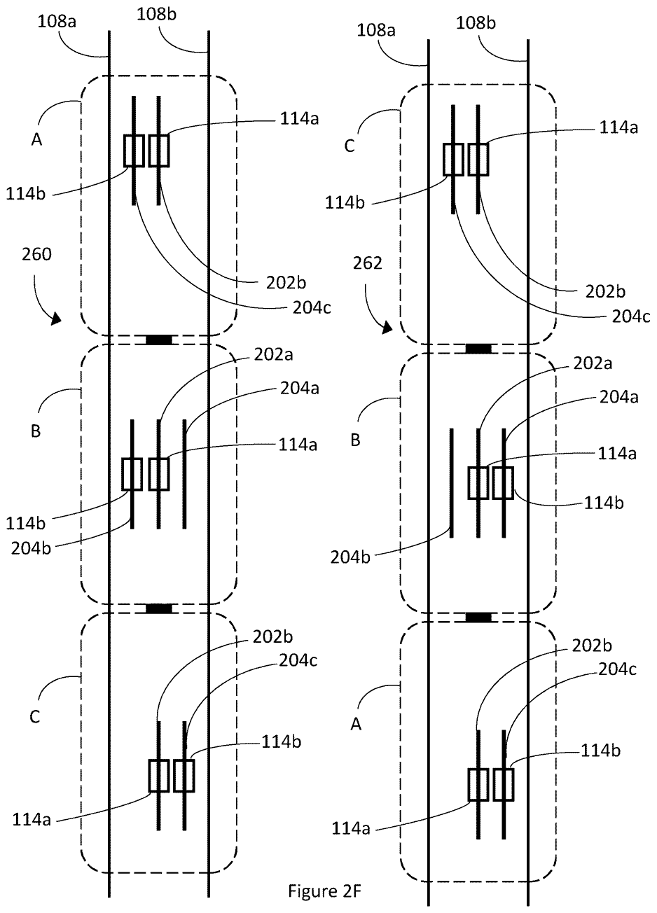

FIG. 2A shows a schematic top view of trackside charging infrastructure 200 configured to interact with the on-board charging apparatus 110 described above. In this context, “trackside” refers to components that are not vehicle based, for example stationary components, for example positioned at, between or near to running rails 108a, 108b.

The trackside charging infrastructure 200 includes a power supply 201 and a trackside charging contact 202a—a schematic side view of the trackside charging contact 202a is shown in FIG. 2B. The trackside charging contact 202a is provided with a connection 203 that is selectively connectable to a first potential of the power supply 201 such that, when a suitable charging shoe 114a is in contact with the trackside charging contact 202a, a charging current can be selectively supplied to the battery 104 as discussed in more detail below.

The power supply 201 is preferably a trackside energy storage means, such as a battery. The power supply 201 is charged via a connection to an electrical power grid, or by local energy generation means (such as photovoltaic panels or wind turbines).

Preferably a controller 218 is provided to control operation of the power supply 201 and the connections 203, 205a, 205b.

In the embodiment shown in FIGS. 2A and 2B, the charging contact 202a is a formed of an elongate steel rail, for example around 4 m long. Preferably, the trackside charging contact 202a comprises a first ramp portion 206a at a first distal end (and optionally a second ramp portion 206b at a second distal end), and a mid-portion 208 adjacent the first ramp portion 206a (and where provided, the second ramp portion 206b). The charging contact has a top surface 209 that extends from the first ramp portion 206a to the mid portion 208 (and where provided, from the mid portion to the second ramp portion 206b). At the mid portion 208 the topmost surface 209 is substantially parallel to running rails 108a, 108b proximate the trackside charging contact 202a. From the mid portion 208, the topmost surface 209 then descends at the first ramp portion 206a (and where provided, the second ramp portion 206b). In the embodiment illustrated in FIGS. 2A and 2B, the trackside charging contact 202a is supported on sleepers 210 (also referred to as ties or crossties) by electrically insulating components 212. The trackside charging contact 202a may alternatively be supported by other structures (e.g. via electrically insulating components 212), for example when the running rails 108a, 108b are not supported by sleepers.

The trackside charging contact 202a is preferably dimensioned such that it can be completely covered by driving motor car 100 or other rail vehicles.

Alternatively, the trackside charging contact 202a may have other configurations or materials.

In the illustrated embodiment, the trackside charging infrastructure 200 comprises a first further stationary contact 204a and a second further stationary contact 204b. Preferably the first and second further stationary contacts 204a, 204b are also formed from steel rails in the same configuration as described above with respect to trackside charging contact 202a. Each of the first and second further stationary contacts 204a, 204b has a respective connection 205a, 205b that is selectively connectable to second potential of the power supply 201 different to the first potential, or to electrical ground. In one example, the trackside charging contact 202a is held at a positive potential during charging and the first and second further trackside charging contacts 204a, 204b are held at a negative potential during charging. During charging of battery 104, either the first or second further stationary contact 204a, 204b provides a return connection via the second charging shoe 114b.

Alternatively, it will be appreciated the trackside charging contact 202a may be selectively connected to the second potential or electrical ground and the first and second further trackside charging contacts selectively connected to the first potential.

In the preferred embodiment, the trackside charging contact 202a is positioned substantially equidistant between the first and second running rails 108a, 108b as shown in FIG. 2A. The first further stationary contact 204a is positioned between the first running rail 108a and the trackside charging contact 202a, and the second further stationary contact 204b is positioned between the second running rail 108b and the trackside charging contact 202a, such that the trackside charging contact 202a is also positioned substantially equidistant between the first and second further stationary contacts 204a, 204b. Correspondingly, the first charging shoe 114a is positioned substantially centrally below the driving motor car 100, that is substantially equidistant between the first and second running rails 108a, 108b as shown in FIG. 1B. Additionally, the second charging shoe 114b is offset from the centre of the driving motor car by a distance corresponding to the distance between the trackside charging contact 202a and each of the first and second further stationary contacts 204a, 204b.

Advantageously, this arrangement allows for direction-agnostic charging—regardless as to the orientation of the driving motor car 100 as it approaches the trackside charging infrastructure 200, the first charging shoe 114a will always be connected to one potential via the trackside charging contact 202a, and the second charging shoe 114b connected to another potential via either the first or second further stationary contact 204a, 204b.

As illustrated, the trackside charging contact 202a and respective further trackside charging contacts 204a, 204b have substantially the same length. However, in some embodiments, the trackside charging contact 202a and respective further trackside charging contacts 204a, 204b have different lengths, which may beneficially facilitate easier installation of connections 203, 205a, 205b.

Optionally, one or more guide rails 214a, 214b are provided. Each guide rail 214a, 214b is positioned proximate to a corresponding running rail 108a, 108b, such that a flange on the wheels of the driving motor car 100 (for example a flange 107 of one of the driving wheels 106) follows a path between the respective guide rail 214a, 214b and the corresponding running rail 108a, 108b. This contains lateral movement of the driving motor car proximate to the trackside charging infrastructure 200, thereby improving alignment of the sharing shoes 114a, 114b relative to the trackside charging contact 202a and the further trackside charging contacts 204a, 204b. The guide rails 214a, 214b are preferably positioned such that wheels of the driving motor car 100 are constrained laterally when the charging shoe 114a is positioned over the trackside charging contact 202a. Though the guide rails 214a, 214b are shown proximate to the trackside charging contact 202a and the further trackside charging contacts 204a, 204b in FIG. 2A, it will be appreciated that they may be positioned or extend some distance in front of and/or behind the trackside charging contact 202a and the further trackside charging contacts 204a, 204b with respect to a direction of travel of rail vehicles.

Optionally edge boards as known in the art (not shown) are positioned either side of one or more of the trackside charging contact 202a and the respective further trackside charging contacts 204a, 204b (for example, which of the charging contacts 202a, 204a, 204b has a non-zero voltage applied to it during charging), so as to prevent/or restrict access to the trackside charging contact 202a and the respective further trackside charging contacts 204a, 204b when the rail vehicle 100 is positioned over the trackside charging infrastructure 200.

An alternative trackside charging infrastructure 250 is shown in FIGS. 2C and 2D. The charging infrastructure 250 employs a trackside charging contact 252 and a further trackside charging contact 254 (for example a single further charging contact 254). Preferably the trackside charging contact 252 is positioned between the first running rail 108a and a midpoint between the first and second running rails 108a, 108b, and the further trackside charging contact 254 is positioned between the second running rail 108b and the midpoint between the first and second running rails 108a, 108b, such that the midpoint between the first and second running rails 108a, 108b is equidistant between the trackside charging contact 252 and the further trackside charging contact 254. In this embodiment, the first charging shoe 114a and the second charging shoe 114b are positioned below the driving motor car 100 such that, when the vehicle 100 travels over the charging infrastructure 250 either the first charging shoe 114a is contactable to the trackside charging contact 252 when deployed and the second charging shoe 114b is contactable to the further trackside charging contact 254 when deployed, or the second charging shoe 114b is contactable to the trackside charging contact 252 when deployed and the first charging shoe 114a is contactable to the further trackside charging contact 254 when deployed, depending on the vehicle's orientation relative to the trackside charging infrastructure 250. The side profile of the trackside charging contact 252 and further trackside charging contact 254 are preferably similar to that of the trackside charging contact 202a shown in FIG. 2B.

In the embodiment shown in FIGS. 2C and 2D, the charging contact 202a is a formed of an elongate steel rail, for example around 4 m long. Preferably, the trackside charging contact 252 comprises a first ramp portion 256a at a first distal end (and optionally a second ramp portion 256b at a second distal end), and a mid-portion 258 adjacent the first ramp portion 256a (and where provided, the second ramp portion 256b). The charging contact has a top surface 259 that extends from the first ramp portion 256a to the mid portion 258 (and where provided, from the mid portion to the second ramp portion 256b). At the mid portion 258 the topmost surface 259 is substantially parallel to running rails 108a, 108b proximate the trackside charging contact 252. From the mid portion 258, the topmost surface 259 then descends at the first ramp portion 256a (and where provided, the second ramp portion 256b).

As with the embodiment of FIGS. 2A and 2B, the trackside charging contact 252 and further trackside charging contact 254 are preferably supported on sleepers 210 (or other structure) via electrically insulating components 212, and guide rails 214a, 214b are preferably provided as described above. A power supply 201 and controller 218 are similarly provided. In the embodiment of FIGS. 2C and 2D, the polarity of the trackside charging contact 252 and further trackside charging contact 254 is selectable. Preferably the trackside charging contact 252 has a connection 253 that is selectively connectable to a first potential of the power supply 201, and a second potential of the power supply 201 different to the first potential or electric ground. Additionally, the further trackside charging contact 254 has a connection 255 that is selectively connectable to a first potential of the power supply 201, and a second potential of the power supply 201 different to the first potential or electric ground. When the driving motor car is oriented such that the first charging shoe 114a is contactable to the trackside charging contact 252 when deployed and the second charging shoe 114b is contactable to the further trackside charging contact 254 when deployed, the trackside charging contact 252 is connected to the first potential of the power supply 201 and the further trackside charging contact 254 is connected to the second potential of the power supply 201 or electrical ground during charging. If the orientation of the driving motor car 100 is reverse such that the second charging shoe 114b is contactable to the trackside charging contact 252 when deployed and the first charging shoe 114a is contactable to the further trackside charging contact 254 when deployed, the further trackside charging contact 254 is connected to the potential of the power supply 201 and the trackside charging contact 252 is connected to the second potential of the power supply 201 or electrical ground during charging. By providing two trackside charging contacts and changing their polarity responsive to vehicle orientation in this way beneficially provides an alternative means for allowing changing of the battery electric vehicle 100 regardless as to its orientation or direction of travel.

A further embodiment is shown in FIG. 2E. In this arrangement, a trackside charging contact 202b and a single further trackside charging contact 204c is provided. In all other respects, this embodiment is identical to the embodiment of FIGS. 2A and 2B. The trackside charging contact 202b is positioned substantially centrally between the running rails 108a, 108b, and the further charging contact 204c is positioned between the trackside charging contact 202b and a running rail 108b. Preferably, one of the trackside charging contact 202b and the further trackside charging contact 204c is permanently connected to ground, with the other being selectively connectable to a voltage source.

The embodiment of FIG. 2E may be provided with the embodiment of FIGS. 2A to 2B. This is illustrated in FIG. 2F. FIG. 2F shows a train rake comprising a first driving motor car A, and second driving motor car C and a trailing car B coupled between the first and second driving cars A, C. The train rake is shown in two different orientations 260, 262 relative to the first and second running rails 108a, 108b—orientation 260 shows driving motor car A leading, and orientation 262 shoes the same train rake reversed, with driving motor car C leading. Each of the first and second driving cars A, C and trailing car is provided with a pair of charging shoes 114a, 114b as described in relation to FIGS. 1A and 1B above, and positioned as described above in relation for FIGS. 2A and 2B. In this arrangement, the trackside charging infrastructure is arranged so as to provide trackside charging contacts that allow charging to take place at each of the driving motor cars A, C and the trailing car B.

As shown in FIG. 2F, trackside charging infrastructure according to the embodiment of FIG. 2E is provided at locations corresponding to the position of the two driving motor cars A, C when stopped. In this embodiment, regardless as to the orientation of the train rake, only a (central) trackside charging contact 202b and a single (offset) further trackside charging contact 204c needs to be provided for the driving motor cars A, C, as can be seen by comparing the orientations 206, 262 in FIG. 2F. However, at a position corresponding to the trailing car B, preferably a (central) trackside charging contact 202a and two (offset) further trackside charging contacts 204a, 204b are provided as per the embodiment of FIGS. 2A and 2B. Changing the orientation of the train rake changes whether one of the charging shoes 114b of the trailing car B is positioned to the left or right of the centre of the trailing car B with respect to its direction of travel. Thus, providing two further trackside charging contacts 204a, 204b ensures that the trailing car B can participate in charging irrespective of the orientation of the train.

### Operation of Shoegear

Operation of the shoegear is now described in relation to the trackside charging infrastructure embodiment of FIGS. 2A and 2B, though it will be appreciated that the steps and provisions below can also be implemented with the trackside charging infrastructure embodiments of FIGS. 2C to 2D and of FIG. 2E.

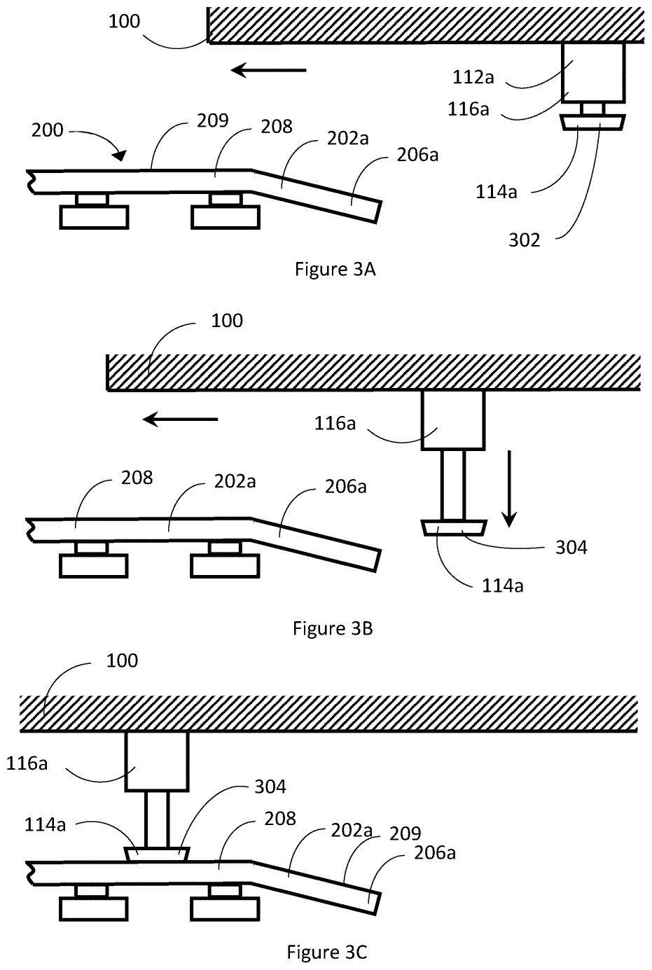

FIGS. 3A to 3C illustrate a preferred method of operating the shoegear 112a, 112b. The FIGS. 3A to 3C show schematic side views of the driving motor car 100 and trackside charging infrastructure 200. For clarity of explanation, several features of the driving motor car 100 and charging infrastructure 200 shown in FIGS. 1A to 2B above have been omitted from FIGS. 3A-3C, however it is to be understood that these features may also be provided.

FIG. 3A shows driving motor car 100 in motion, travelling towards the trackside charging contact 202a (right to left as shown). At this stage, the charging shoe 114a is in a retracted position 302. When in the retracted position 302, the charging shoe 114a is held within the applicable vehicle gauge requirements for the route being taken by the driving motor car 100 (for example, above the gauge line as defined in RSSB standard GE/RT8073). In some examples, when in the retracted position 302, the lowest part of the charging shoe 114a is held at position higher than the lowest part of the motor 102.

Responsive to detecting that the driving motor car 100 is approaching the trackside charging contact 202a, the controller 118 instructs the actuator 116a to move the charging shoe 114a from the retracted position to a deployed or extended position 304, as shown in FIG. 3B. This is performed before the driving motor car 100 has stopped at the charging infrastructure 200, for example, while the driving motor car 100 is still in motion towards the trackside charging contact 202a. When in the deployed position 304, the charging shoe 114a is held beneath the driving motor car 100 at a height such that it will come into contact with the topmost surface 209 of the trackside charging contact 202a as the driving motor car 100 travels over the trackside charging contact 202a. Consequently, as the driving motor car 100 continues to move, the charging shoe 114a slides across a portion of the topmost surface 209 of the trackside charging contact 202a. Preferably, when in the deployed position 304, the charging shoe is sufficiently low to contact the topmost surface 209 of the ramp portion 206a, thus the charging shoe 114a slides up the ramp portion 206a and along a portion of the mid portion 208 of the trackside charging contact 202a. In some examples, the charging shoe 114a is held at a position around 125 mm lower in the deployed position as compared to the retracted position.

In FIG. 3C, the driving motor car 100 has stopped such that the charging shoe 114a (which remains in the deployed position 304) is still in contact with the trackside charging contact 202a. While the driving motor car 100 is stationary, charging can proceed as outlined below.

It will further be appreciated that the operations illustrated in FIGS. 3A to 3C can be reversed. For example, a driving motor car 100 is initially stationary over trackside charging infrastructure 200 with the charging shoe 114a in the deployed position 304 and in contact with the trackside charging contact 202a, as shown in FIG. 3C. After any charging has finished, the driving motor car 100 begins to move with the charging shoe 114a remaining in the deployed position 304 such that it slides over a portion of the topmost surface 209 of the trackside charging contact 202a. The controller 118 subsequently instructs the actuator 116a to move the charging shoe 114a from the deployed position 304 to the retracted position 302.

Accordingly, prior to the driving motor car 100 being stationary over the charging infrastructure and prior to charging commencing, the charging shoe 114a contacts and slides across at least a portion of the topmost surface 209 of the trackside charging contact 202a. Similarly, after charging has occurred the driving motor car begins to move, and again the charging shoe 114a contacts and slides across at least a portion of the topmost surface 209 of the trackside charging contact 202a. This advantageously serves to ensure a low resistance electrical connection between the charging shoe 114a and the trackside charging contact 202a. By sliding the charging shoe 114a across the trackside charging contact 202a in this way, dirt that has been deposited on the trackside charging contact 202a is at least partially swept away and similarly rust/corrosion that might have formed on the trackside charging contact 202a is at least partially abraded away. This thus ensures a clean contact between the charging shoe 114a across the trackside charging contact 202a. Moreover, the applicant has found that over time, sliding the charging shoe 114a across the trackside charging contact 202a builds up a layer of carbon/copper shoe material on the trackside charging contact 202a—this not only improves electrical conductivity at the topmost surface 209 of the trackside charging contact 202a, but also acts to inhibit corrosion that might otherwise reduce conductivity. As a result, the present invention reduces resistive losses during charging, leading to more efficient/faster charging of electric rail vehicle batteries via trackside charging infrastructure.

Returning to FIG. 3C, in the preferred embodiment, the actuator is configured to maintain a force greater than a threshold force between the charging shoe 114a (in the deployed position 304) and the trackside charging contact 202a while the driving motor car 100 is stationary. For example, where actuator 116a is a pneumatic actuator, controller 118 monitors the air pressure of the actuator to confirm that it is above a threshold pressure. Advantageously, this helps ensure that the charging shoe 114a in the deployed position 304 remains in good physical and electrical contact with the trackside charging contact 202a during charging. In particular, this allows the on-board charging apparatus 110 to dynamically respond to changes in total mass caused by passengers alighting the driving motor vehicle 100. Put differently, if the battery electric rail vehicle 100 raises on its suspension as a result of passengers disembarking, the actuators advantageously ensure that the contact shoe 114a stays in good electrical contact with the trackside charging contact 202a.

Though FIGS. 3A to 3C explain the principle of operation of the first charging shoe 114a, the second charging shoe 114b is preferably operated in a corresponding way, providing the same benefits in relation to improved electrical contact between the second charging shoe 114b and the first/second further trackside charging contacts 204a, 204b, again leading to more efficient/faster charging of electric rail vehicle batteries via trackside charging infrastructure.

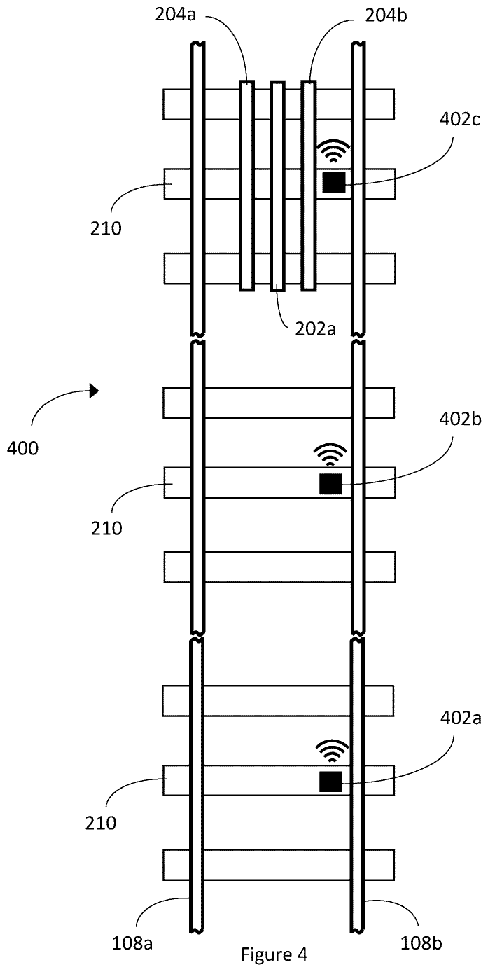

In the preferred embodiment, the controller 118 is configured to operate the on-board charging apparatus 110 based (at least in part) on signals received by the receiver 120. FIG. 4 shows a schematic partial top view of a section of track 400. On the approach to the trackside charging contact 202a and first and second further trackside charging contacts 204a, 204b, there is provided one or more transmitters 402a, 402b, 402c. Preferably the one or more transmitters 402a, 402b, 402c are RFID transponders or “beacons”. When the receiver 120 is within a certain range (for example around 600 mm) of a respective transmitter 402a, 402b, 402c, it interrogates the respective transmitter 402a, 402b, 402c. In response to the interrogation, the respective transmitter 402a, 402b, 402c transmits a predetermined signal in a manner known in the context of RFID transponders.

An optional first transmitter 402a is configured to transmit a signal indicative that the driving motor car 100 is on a route for which charging infrastructure 200. For example, the signal may indicate that the driving motor car 100 is following a route corresponding to a certain platform in a station, and that charging infrastructure 200 is available for that platform. RFID beacons often already exist proximate to the entrance to a length of track adjacent to a platform, and transmit a signal indicating which side of the train the platform will be, and therefore which side of the train doors should be opened once the train is stationary. Advantageously, known RFID beacons of this kind could be easily employed to also indicate whether charging infrastructure 200 is available.

A second transmitter 402b is configured to transmit a signal instructing that the one or more charging shoes 114a, 114b should be deployed. As the driving motor car 100 travels over the second transmitter 402b, the receiver 120 detects this signal, and in response the controller 118 causes the actuators 116a, 116b to move the charging shoes 114a, 114b, from their respective retracted positions 302 to their deployed positions 304. Advantageously, this provides a simple and robust means for determining when to deploy the charging shoes 114a, 144b. The second transmitter 402b is positioned relative to the trackside charging contact 202a and first and second further trackside charging contacts 204a, 204b such that there is sufficient time for the actuators 116a, 116b to fully deploy before reaching the trackside charging contact 202a and first and second further trackside charging contacts 204a, 204b, accounting for an expected speed profile of the driving motor car 100. Preferably the second transmitter 402b is also positioned as close to the trackside charging contact 202a and first and second further trackside charging contacts 204a, 204b as possible, so as to reduce any risk that a deployed charging shoe 114a, 114b could interfere with other items or infrastructure located between the running rails 108a, 108b.

A third transmitter 402c is preferably provided proximate to the trackside charging contact 202a and first and second further trackside charging contacts 204a, 204b, and is configured to transmit a signal indicative that the driving motor car 100 is in a position suitable for charging to commence. Preferably the range of the third transmitter 402c is such that its signal is only transmitted when the first charging shoe 114a is in contact with the topmost surface 209 in the mid portion 208 of the trackside charging contact 202a, to further optimise electrical contact.

It will be appreciated that the transmitters 402a, 402b, 402c can be placed in a variety of positions relative to the running rails 108a, 108b. As shown in FIG. 4, the transmitters 402a, 402b, 402c are positioned on sleepers 210, between the running rails 108a, 108b, and offset from a midpoint between the running rails 108a, 108b. The transmitters 402a, 402b, 402c (and correspondingly receiver 120) can alternatively be placed at or closer to the midpoint between the running rails 108a, 108b, or even positioned outside of the running rails 108a, 108b (for example to the left of running rail 108a, or to the right of running rail 108b in the reference frame of FIG. 4).

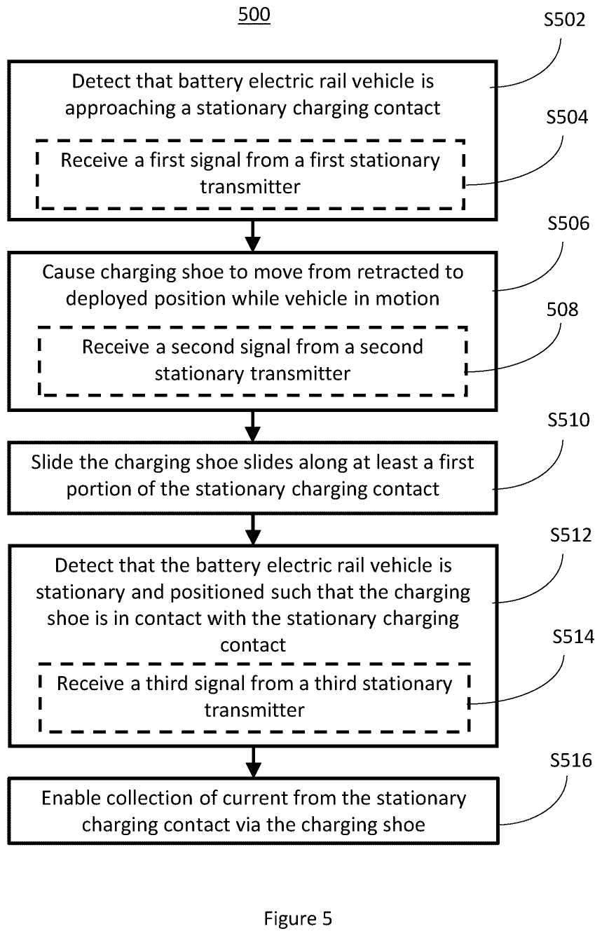

A flow diagram illustrating a method 500 for operating the charging shoe 214a is shown in FIG. 5. The method 500 begins as a battery electric vehicle, such as a train comprising driving motor car 100 travels along running rails 108a, 108b towards charging infrastructure 200. At step S502, it is detected that the battery electric vehicle is approaching a trackside charging contact 202a.

Optionally this involves receiving a first signal indicative that the battery electric vehicle is on a route that includes charging infrastructure 200 and is heading towards the charging infrastructure from a first stationary transmitter 402a in step S504. For example, a first RFID transponder 402a may transmit the signal in response to being interrogated by vehicle-based RF transceiver 120. Alternatively, detection of approaching the trackside charging contact 202a involves receiving a second signal from a second stationary transmitter 402b in step S508 including an indication that the charging shoe 214a should be deployed-thus providing an implicit indication that the battery electric vehicle is approaching the trackside charging contact 202a.

At step S506, the controller 118 causes the actuator 116a to move the charging shoe 114a from the retracted position 302 to the deployed position 304, before the battery electric vehicle has stopped over the trackside charging contact 202a. For example, the charging shoe 114a may be moved to the deployed position while the battery electric vehicle is still moving. Optionally, the controller 120 instructs the actuator 120 to move the charging shoe 114a to the deployed position 304 responsive to receiving a signal transmitted from a second stationary transmitter 402b in step S508. For example, a second RFID transponder 402b may transmit the signal in response to being interrogated by vehicle-based RF transceiver 120. In some embodiments additional charging shoes can be provided at other positions along a train, for example at a second driving motor car and/or at an intermediate carriage—in these situations, detection of the second signal from a second stationary transmitter 402b in step S508 preferably causes all charging shoes to be deployed substantially simultaneously.

At step S510, the charging shoe 114a in the deployed position 304 is brought into contact with the trackside charging contact 202a as the battery electric rail vehicle continues to move, thereby sliding/wiping/dragging the charging shoe 114a along at least a portion of a surface 209 of the trackside charging contact 202a. As above, this advantageously acts to clean debris and corrosion from the trackside charging contact 202a, as well as build up a conductive and corrosion resistant layer.

At step S512, it is detected that the battery electric rail vehicle is stationary, and positioned such that the charging shoe 114a in the deployed position 304 is in contact with the trackside charging contact 202a. Optionally this involves detecting (for example continuously detecting) a signal transmitted from a third stationary transmitter 402c in step S514. For example, a third RFID transponder 402c may transmit (for example continuously transmit) the signal in response to being interrogated by vehicle-based RF transceiver 120.

At step S516, charging of the vehicle's battery/batteries 104 commences. Trackside charging contact 202a is connected to a suitable power supply/energy storage, and charging shoe 114a is connected to the battery/batteries 104 thereby enabling collection of a charging current to charging the battery. Preferably, the charging process is subject to further interlocks and processes as described below. In embodiments where additional charging shoes are provided at other positions along a train, detecting the signal transmitted from a third stationary transmitter 402c in step S514 preferably causes charging to begin via all charging shoes and corresponding charging infrastructure 200.

It will be appreciated that the steps S506, S510 and S512 may be performed in reverse, for example after a charging process in step S516 has ceased. In particular, as the battery electric rail vehicle begins to move, the charging shoe 114a remains in contact with the stationary charging rail 202a, thereby sliding/wiping/dragging the charging shoe 114a along at least a portion of a surface 209 of the trackside charging contact 202a. Subsequent to this, the controller 118 instructs the actuator 116a to move the charging shoe 114a to the retracted position.

While it is preferred that the on-board charging apparatus and shoe deployment techniques, the trackside charging infrastructure, and the charging process described above are provided together, it will be appreciated that the on-board charging apparatus and shoe deployment techniques can be utilised with different trackside charging infrastructure, and charging processes. Likewise, the trackside charging infrastructure described above can be provided with different on-board charging apparatus and charging processes. Similarly, the charging processes described above may be provided with different on-board charging apparatus and trackside charging infrastructure.

The above embodiments are provided as examples only—the scope of the invention is defined by the appended independent claims. Further aspects of the invention will be understood from the appended claims.

1. A charging apparatus for installation on an electric rail vehicle having a battery, the charging apparatus comprising:
a controller;
a charging shoe electrically connectable to a battery wherein:
the charging shoe is configured to be movable between a retracted position and a deployed position,
the charging shoe is electrically connectable to a trackside charging contact when in the deployed position, and
wherein the controller is configured to detect a position of the electric rail vehicle relative to the trackside charging contact, and cause the charging shoe to:
move from the retracted position to the deployed position prior to the charging shoe being positioned over the charging contact, and/or while the battery electric rail vehicle is in motion, thereby sliding the charging shoe along at least a first portion of the trackside charging contact.

2. The charging apparatus of claim 1 wherein the controller is further configured to cause the charging shoe to move from the deployed position to the retracted position subsequent to the electric rail vehicle starting to move away from the trackside charging contact, thereby sliding the charging shoe along at least a second portion of the trackside charging contact.

3. The charging apparatus of claim 1 further comprising a receiver configured to receive a first signal from a first trackside transmitter, wherein the controller is configured to cause the charging shoe to move from the retracted position to the deployed position in response to the receiving the signal.

4. The charging apparatus of claim 3, wherein the receiver is configured to receive a second signal from a second trackside transmitter, and wherein the controller is configured to determine that the electric rail vehicle is positioned such that the charging shoe in the deployed position is in contact with the trackside charging contact based at least in part on the receipt of the second signal.

5. The charging apparatus of claim 1, further comprising an actuator configured to move the charging shoe from the retracted position to the deployed position, wherein:
when the charging shoe is in the deployed position and in contact with the stationary charging rail, and the battery electric rail vehicle is stationary, the controller is configured to cause the actuator to maintain a force between the charging shoe and the stationary charging rail above a threshold force.

6. The charging apparatus of claim 1 further comprising a marker detectable by a trackside proximity sensor, where in the controller is configured to determine that the electric rail vehicle is positioned such that the charging shoe in the deployed position is in contact with the trackside charging contact based at least in part on receiving an indication that the marker has been detected by a trackside proximity sensor.

7. A rail vehicle comprising the charging apparatus of claim 1.

8. A method of charging a battery electric rail vehicle having a charging shoe, wherein the charging shoe is configured to move between a retracted position to a deployed position and wherein the charging shoe is electrically connectable to a trackside charging contact when in the deployed position, the method comprising:
detecting that the battery electric rail vehicle is approaching the trackside charging contact;
causing the charging shoe to move from the retracted position to the deployed position prior to the charging shoe being positioned over the charging contact, and/or while the battery electric rail vehicle is in motion;
contacting the trackside charging contact with the charging shoe in the deployed position as the battery electric rail vehicle continues to move, such that the charging shoe slides along at least a first portion of the trackside charging contact.

9. The method of claim 8, wherein detecting that the battery electric rail vehicle is approaching a trackside charging contact comprises receiving, at a receiver at the rail vehicle, a first signal from a first trackside transmitter.

10. The method of claim 8, wherein the charging shoe is caused to move from the retracted position to the deployed position responsive to receiving, at a receiver, a second signal from a second trackside transmitter.

11. The method of claim 8 further comprising detecting that the battery electric rail vehicle is positioned such that the charging shoe is in contact with the trackside charging contact by one or more of:
receiving, at a receiver, a third signal from a third trackside transmitter;
determining that a trackside marker has been detected by an on-board proximity sensor; and
determining that an on-board marker has been detected by a trackside proximity sensor.

12. The method of 8 further comprising:
maintaining contact between the charging shoe in the deployed position as the battery electric rail vehicle starts to move, such that the charging shoe slides along at least a second portion of the trackside charging contact;
subsequently causing the charging shoe to move from the deployed position to the retracted position.

13. A battery electric rail vehicle charging system comprising:
a battery electric rail vehicle comprising:
first wheels configured to run on a first running rail and second wheels configured to run on a second running rail,
a battery,
a first charging shoe, and
a second charging shoe;
a trackside charging infrastructure comprising;
a trackside charging contact configured to be connected to a first electrical potential during charging of the battery;
a first further trackside charging contact connectable to a second electrical potential during charging of the battery;
wherein
the trackside charging contact is positioned substantially equidistant between a first running rail and a second running rail;
the first further trackside charging contact is positioned between the trackside charging contact and the first running rail;
the first charging shoe is positioned so as to be contactable to the trackside charging contact, and wherein the second charging shoe is positioned so as to be contactable with the first further trackside charging contact for a first orientation of the battery electric rail vehicle relative to the first running rail and second running rail.

14. The battery electric rail vehicle charging system of claim 13, further comprising a second further trackside charging contact connectable to a second electrical potential during charging of the battery, the second further trackside charging contact positioned between the trackside charging contact and the second running rail;
wherein the second charging shoe is positioned so as to be contactable with the second further trackside charging contact for a second orientation of the battery electric rail vehicle relative to the first running rail and second running rail.

15. The battery electric rail vehicle charging system of claim 13, wherein:
the battery electric vehicle further comprises an on-board controller, and the first charging shoe is movable between a retracted position and a deployed position; and
the on-board controller is configured to control the first contact shoe to:
move from the retracted position to the deployed position prior to the charging shoe being positioned over the charging contact, and/or while the battery electric rail vehicle is in motion, thereby sliding the charging shoe along at least a first portion of the trackside charging contact, and/or
move from the deployed position to the retracted position subsequent to the electric rail vehicle starting to move away from the trackside charging contact, thereby sliding the charging shoe along at least a second portion of the trackside charging contact.
